(19) United States
(12) Patent Application Publication
(10) Pub. No.: US 2003/0208404 A1
(43) Pub. Date: Nov. 6, 2003

(54) Computer system and method for promoting business of a merchant

(76) Inventor: David Michie, Maple Glen, PA (US)

Correspondence Address: SYNNESTVEDT & LECHNER, LLP, 2600 ARAMARK TOWER, 1101 MARKET STREET, PHILADELPHIA, PA, 191072950

(21) Appl. No.: 10/427,336

(22) Filed: May 1, 2003

Related U.S. Application Data
(60) Provisional application No. 60/377,762, filed on May 3, 2002.

(51) Int. Cl. G06F 17/60

(52) U.S. Cl. 705/14

(57) ABSTRACT

The method of the present invention is directed to promoting a merchant comprising providing merchant-specific configuration software for specially configuring a user's computer system and/or computer peripheral device, such as a computer mouse or keyboard, to access a website and/or an advertisement by the activation of at least one switch by the user.

### BACKGROUND OF THE INVENTION

1. Field of the Invention

The present invention relates to computer systems, computer peripheral devices, software for controlling the operability of computer peripheral devices, and business methods for promoting business. More particularly, the present invention relates to methods of promoting business of a merchant using a specially configured computer system.

2. Discussion of the Related Art

As Internet technologies continue to develop and new online services become available, more users are accessing the Internet. Typically, if a user wishes to access a particular Website (or Web page) via the Internet, the user runs Web browser software installed on the user's computer. The Web browser connects the computer to the Internet, e.g., through a modem or a network card. The user types in a Web address or URL (Uniform Resource Locator) of the desired Website using the keyboard, or clicks on-screen icons provided by the Web browser to select one of the stored Website addresses. The Web browser processes the Website request (i.e., the URL request) and transmits it to an appropriate server (e.g., a proxy server or an application server) via the Internet. The server responds to the Website request and transmits to the Web browser a Web page (e.g., in HyperText Markup Language or HTML files) corresponding to the requested Website. The Web browser receives the Web page and displays it on the user's computer's video monitor, whereby the user has accessed the desired Website.

The above-described conventional process of accessing a Website, however, is inconvenient to the user because the user must often either type in the URL, which often is lengthy and difficult to remember, or click on multiple icons to select one of the stored URLs. From the perspective of electronic business merchants (hereinafter “e-merchants”), the burdensome conventional process hinders potential customers from accessing the e-merchants' Websites, which can result in a significant loss of profit for the e-merchants.

Thus, there is a need for a system and method that overcomes the problems involved with the conventional method of accessing Websites. Further, a need exists for a system and business method that simplifies accessing of e-merchant Websites and/or displays advertisements for such e-merchants, and thereby promotes the business of merchants and/or conducting of online transactions through the e-merchants' Websites.

U.S. application Ser. No. 09/742,026, filed Dec. 21, 2000, the entire disclosure of which is hereby incorporated herein by reference, which is commonly assigned herewith, discloses a specially configured computer peripheral device (CPD), such as a computer mouse, and a method of promoting the business of emerchants using the CPD. As disclosed therein, a marketing service is provided to a plurality of merchants that are interested in promoting their online businesses. The marketing service provides specially configured “merchant-specific” computer peripheral devices, such as computer mice, to preselected recipients or directly to the merchant. The devices are specially configured for each merchant in that Website information associated with the merchant or a Website access triggering signal is programmed into the CPD. Merchant-specific information, such as a logo, may also be provided on a surface of the CPD. These merchant-specific devices are typically distributed to the preselected recipients, e.g., current or potential customers or vendors of the merchant.

Once a recipient's computer is configured to accept commands from the specially configured CPD, the recipient can press at least one pre-configured switch (a Web switch) on the CPD and be connected automatically to a Website provided or selected by the merchant without the need to type in a Website's address, select icons, etc.

In effect, the Web switch of the specially configured CPD provides the user with one-button access to a Website of the merchant's choosing, e.g., the merchant's Website. The convenience of accessing the merchant's Website(s) using the Web switch encourages more frequent access of the e-merchant's Website(s) by the recipient. These devices are typically distributed at the merchant's expense.

Applicant has recognized that there may be undesirable expense associated with distribution of such CPD's and/or compatibility difficulties associated with some computer systems. Accordingly, what is needed is a method of promoting business that eliminates the need for distribution of a specially configured computer peripheral device and associated expenses.

Applicant has further recognized that it may be desirable to allow a user to specify a Website that the user wishes to access in a simplified manner. Accordingly, what is needed is a specially configured computer system, and/or software for specially configured hardware of a conventional computer system, that allows a user to specify a Website while still allowing for promotion of a merchant's business, e.g. the merchant paying to enable the specially configured computer system.

### BRIEF DESCRIPTION OF THE DRAWINGS

FIG. 1 is a block diagram for illustrating business methods in accordance with the present invention.

FIG. 2 is a pictorial representation of a computer mouse in accordance with the present invention.

FIG. 3 is a block diagram of a specially configured computer system in accordance with the present invention.

FIG. 4 is a flow diagram of an exemplary business method in accordance with the present invention.

### DETAILED DESCRIPTION OF THE PREFERRED EMBODIMENTS

As used herein, a “merchant” can be an e-merchant, vendor, sponsor or provider of a Website such as ISPs, ASPs, etc., or even a merchant that does not engage in online commerce. The terms “merchant” and “e-merchant” are used herein interchangeably and are intended to include both for-profit and non-profit entities, such as those that maintain an Internet presence.

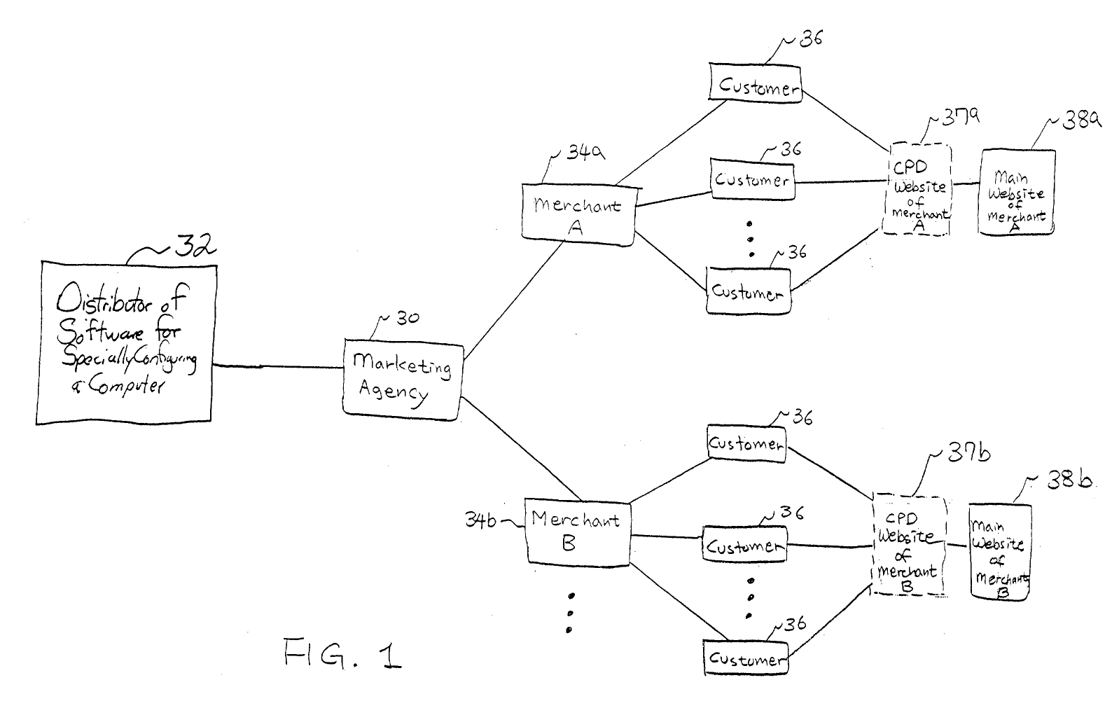

FIG. 1 shows a block diagram of an embodiment of a method for promoting a business in accordance with the present invention. Referring to FIG. 1, a marketing agency 30 provides the unique marketing service of the present invention to a plurality of merchants 34a, 34b, etc. The marketing agency 30 may be any entity that provides this marketing service, e.g., RCG International, Inc. located in Maple Glen, Pa. The merchants 34a, 34b may be e-business merchants having Websites (e.g., General Electric, Inc., E*trade Securities, Inc., Professional Golf Association, etc.) as well as any other entity that sponsors Websites, e.g., ISPs, ASPs, search engine providers, etc., or even entities that do not have Websites.

The marketing service of the present invention involves providing “merchantspecific” configuration software for specially configuring a user's computer system and/or computer peripheral device (collectively, “computer system”) in accordance with the present invention. The software is specifically configured for each merchant 34a, 34b. Any computer system may be used, preferably a computer system already owned by the user, thereby eliminating the costs of manufacturing and distributing specially configured CPD's and/or any compatibility difficulties that may be associated with such CPD's. Additionally, connectivity problems, e.g. via PS/2, USB, or other ports, is avoided because the software is hardware-independent—it merely causes monitoring of a user's computer system and assigns functionality to a predetermined trigger event, such as assigning launching of a Web browser and/or display of a Web page and/or advertisement upon occurrence of the trigger event, such as a double click of a right mouse button, or any other unique act to which functionality is not already assigned. For example, this can be implemented with a software “hook,” as is well known in the art. After the computer system is specially configured in accordance with the present invention, e.g. by installing software in accordance with the present invention, the computer system provides functionality of at least one specially programmed switch. Upon activation of the switch by a user, predetermined functionality is provided. For example, activation of the switch may automatically connect the user to a predetermined Website, connect the user to a predetermined Website and cause display of an advertisement, e.g. in a browser Window (such as an advertisement of a merchant paying to distribute the software), may launch a preferred software application (specified by the merchant or user), with or without display of an advertisement, etc.

Accordingly, the present invention provides simplified, e.g. one-button, access to a predetermined Website (or other functionality) without a specially configured CPD, but rather, using a user's existing computer system hardware as specially configured in accordance with the present invention. For illustrative purposes, the invention is discussed below with reference to access to a Website.

In one embodiment, the predetermined Website is associated with and/or specified by the merchant. For example, actuation of the Web switch may cause the user's computer system to display the merchant-selected Website. In such an embodiment, the user is encouraged to use the switch to easily launch a Web browser and access the Web/Internet, and the merchant's business is promoted by display of the merchant's Website each time the switch is used. It should be noted that the user may still choose a “home” Website within the Web browser, as is well known in the art.

In an alternative embodiment, the predetermined Website is specified by the user, but an advertisement associated with the merchant is automatically displayed in conjunction with the user-specified Website. In such an embodiment, an initial predetermined Website may be specified by the marketing agency or another whereby the user can specify a predetermined Website of his choosing. For example, this may involve storage of appropriate data as a cookie with the user's computer system. Because an advertisement associated with the merchant is displayed each time (or as desired) the user uses the specially configured switch, the merchant's business is promoted by use of the switch. In such an embodiment, the user wishes to have simplified access to a Website of his choosing, and so will continue to use the switch, and the merchant's business is promoted each time by display of the merchant's advertisement each time the switch is used. It should be noted that this is different from a conventional banner advertisement displayed on a Website, or a pop-up advertisement launched when a user visits a Website with which the advertisement is associated, which typically requires the merchant to pay the Website owner.

Conceptually, in some embodiments, the present invention allows the user to have simplified access to certain functionality (as may be determined by the user or merchant) in exchange for viewing of an advertisement of the merchant each time (or as desired) the simplified access switch is used by the user.

In another embodiment, upon actuation of the specially programmed switch, the user is first connected to a Computer Peripheral Device (CPD) Website, which automatically redirects the user to another Website, such as the home page of the merchant. In this embodiment, the CPD Website can function as a tracking site, for tracking the timing and frequency of Website access by the users using the specially programmed switch. The tracking information can be used in market studies and research to further improve the business of the merchant.

Alternatively, the CPD Website can function as an advertisement server to provide advertisements to be displayed independently of the Website, e.g. in a separate pop-up window displayed by a Web browser. The advertisement is preferably smaller than, and partially overlies, the main Web browser window displaying the predetermined Website. It should be noted that the term “advertisement” is used herein in a broad sense to include more than a traditional advertisement. For example, the advertisement may include any desired promotional information, such as coupons, sweepstakes information, tips, advice, or any other information desired to be distributed by the merchant. Preferably, the advertisement is configured with a hyperlink so that the user may access merchant's homepage or another portion of its Website by performing a single act, such as by clicking a designated icon on the CPD Website.

While a computer mouse is a preferred computer peripheral device of the present invention that may be used in accordance with the present invention, other examples include, but are not limited to, keyboards, keypads, styluses, touch-sensitive screens, etc.

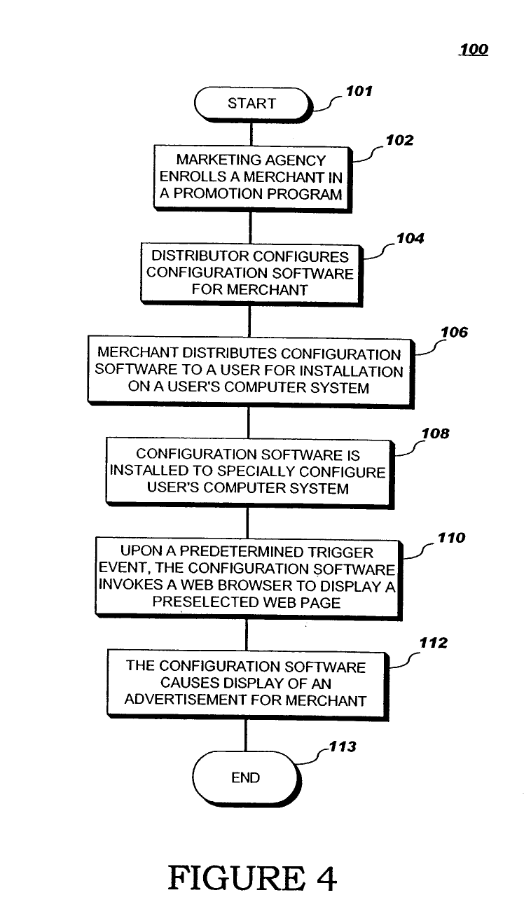

A method of promoting business is now described according to one embodiment of the present invention with reference to FIGS. 1 and 4. The marketing agency 30 enters into an agreement with each merchant 34a, 34b that is interested in receiving the marketing service offered by the marketing agency 30. In other words, the marketing agency enrolls a merchant in a promotion program as shown at step 102 of FIG. 4.

In accordance with the agreement, the marketing agency 30 instructs a distributor 32 to produce merchant-specific configuration software for specially configuring a computer system computer peripheral device (e.g., a computer mouse) for the merchant 34a, 34b. For example, if a merchant 34a such as General Electric, Inc. (GE) agrees to receive the marketing service of the marketing agency 30, the marketing agency 30 instructs the distributor/programmer 32 to produce configuration software to specially configure a user's computer system such that a trigger event is associated with at least one predetermined Web address. This is shown at step 104 of FIG. 4.

For example, the trigger event may be a double click of the right button of a mouse (“double right click”) (for a right handed user, for a left-handed user, it could be configured as a double left click). Functionality is typically assigned to a double-click of the right button of a mouse only when the mouse is configured for use by a left-handed user, at which time the right mouse button functions as a left mouse button of a mouse configured for use by a right-handed user. However, a typical operating system, such as a Microsoft operating system, is preconfigured to recognize a double right click although functionality is not assigned for such an event. Accordingly, this software may be implemented to use a double right click as the trigger event in a straightforward manner, as will be appreciated to those skilled in the art. Alternatively, for example, a single or double click of a middle button of a three-button mouse could be used. For example, the software may use a “hook” to provide such functionality.

It should be noted, however, that another mouse button itself, such as a scroll wheel button, or mouse button sequence may be used as the trigger event. Alternatively, keyboard keystroke combinations, e.g. Ctrl-W, or typing a Web address into a Web browser, may also function as the trigger event.

The software is preconfigured to direct a Web browser to a predetermined Website upon occurrence of the trigger event. For example, if General Electric, Inc. agrees to enroll in a promotion program in accordance with the present invention and distribute software configured by the marketing agency, distributor, and/or the merchant itself (e.g. via e-mail, Web download, making of computer media storing the software, etc., to promote General Electric, the software may cause General Electric's Website at www.ge.com to be displayed upon activation of the switch, e.g. by a double right click of the mouse. In such an embodiment, the Website and Website address is specified by the merchant and is fixed by the marketing agency and/or distributor/programmer and cannot be modified by the user.

Alternatively, the software may be configured to permit the user to specify the URL to be associated with the trigger event, as described above. For example, in such a case, the software may be preconfigured to direct a Web browser to a registration Web page of the marketing agency where a user may specify the URL of the Website he wishes to associate with the trigger event and the Website may store an appropriate cookie on the user's computer to cause the occurrence of the trigger event to invoke the Web browser to direct the user's Web browser to the user-selected Website. In such an embodiment, the Website URL may be customized and/or changed by the user. However, in such an embodiment, it is advantageous that the software is further configured to display an advertisement, e.g. in the form of a small window displayed by a Web browser, of the merchant's choosing. For example, this may involve providing a URL to the merchant's Website or server, or the marketing agency's Website or server, to retrieve and display a selected advertisement in a separate window. This information may be carried by the configuration software, and stored on the user's computer system, when the configuration software is installed. In this manner, the user may select the Web page of his choosing but not the advertisement. Rather the advertisement is selected by the sponsor/merchant/distributor of the software who is paying for distribution of the software. The ability of the user to customize the software to allow him easy access via the predetermined event to the Website of his choosing encourages the user to continue using the software and as a result the user will continue viewing the merchant's advertisements, and the merchant's business will thereby be promoted.

Additionally, redirect technology may be used to drive Web traffic to the merchant's, marketing agency's or another's Website for traffic and/or tracking purposes.

The marketing agency 30, distributor 32 or merchant 34a, 34b, or any entity designated by the merchant 34a, 34b then delivers the merchant-specific configuration software to intended recipients, e.g., current or potential customers 36, e.g., either at no cost or for a fee. Each customer 36 installs the merchant-specific computer software on his or her computer system, e.g. a personal computer (PC). For example, the distribution and installation may be performed via a Web download, as is known in the art. This is shown at steps 106 and 108 of FIG. 4. Accordingly, the user's existing hardware may be used, thereby reducing the likelihood of compatibility problems with CPDs and thereby eliminating the need for the marketing agency/merchant to pay for and/or distribute specially configured hardware while still permitting the merchant to promote his business.

When the customer 36 actuates the specially programmed switch of his computer system (assuming that the computer is loaded with an appropriate Web browser, is connected to the Internet and is turned on), a triggering signal is then transmitted with the computer system within the PC. The specially configured software then causes a response to the triggering signal of retrieving the prestored Web address of the predetermined Website (e.g. CPD Website 37a) from its memory, and processes it as a Website request according to known techniques. This Web address is either provided by the configuration software (after being configured for a specific merchant) or is selected by the user and stored as a cookie, as described above. Directing the user's Web browser to a CPD Website (i.e. a Website address) allows the merchant or another to easily change what the user will see, without any change in configuration at the user's client/computer system, by simply changing what materials are posted or retrievable at the CPD Website address. When the merchant's CPD Website address is different from the merchant's Website address, information accessible via the CPD website address can be changed without disturbing the merchant's Website.

For example, if the configuration software is specially configured to promote GE as a merchant, and the user has installed the computer on his computer system, and the specially configured software is configured to permit the user to select a preferred Website for display upon use of the Web switch and the Web switch is configured to be activated upon a double right click of a mouse button, then when the user performs a double right click of his mouse button, the configuration software causes his computer system to launch its Web browser, retrieve the URL specified by either the merchant, e.g. www.ge.com (at which time GE's website is displayed) or by the user (www.user'sfavoriteWebsite.com) (at which time GE's advertisement is displayed in conjunction with the user's favorite Website). For example, the advertisement for GE may be retrieved from ge.com, the marketing agency's Website, or elsewhere, as may be specified in the configuration software when it is customized for GE as a merchant. These steps are shown in steps 110 and 112 of FIG. 4.

In one embodiment, the CPD Website 37a may function solely as a tracking site for the main Website 38a of the e-merchant, for maintaining data indicating the access frequency and times at which the main Website 38a is accessed using the specially configured switch. Thus, in response to the Website request, a server associated with the CPD Website 37a may return a “redirect” page to the customer's PC while it redirects the customer 36 to the page of the main Website 38a and increases the access count. The page (e.g., Home Page) of the main Website 38a of the merchant 34a will be displayed on the PC. A redirect page may provide a notice to the customer 36 that he or she is being redirected to the main Website 38a. It may also provide merchant-specific information, e.g., advertising or company information, which can be viewed for a short time period during which the redirect page is displayed to the customer 36.

In accordance with another embodiment, the CPD Website 37a can function as a promotional site for the merchant 38a for displaying ads, sales, and other information, and the system may not redirect the customer 36 automatically from the CPD Website 37a to another Website 38a. This will give the customer 36 an opportunity to view the information provided by the CPD Website 37a and select hyperlinks displayed thereon. Promotional schemes for promoting the use of the computer peripheral devices can be incorporated into this embodiment. For instance, the merchant 36a may select (randomly or according to some predetermined criteria) a prize winner from the customers who access the CPD Website 37a using the computer peripheral devices. The announcement whether the current customer 36 is a winner may be displayed on the Web page of the CPD Website 37a immediately after the customer 36 actuates the Website switch on the peripheral device or may be delivered via other means, e.g., email. The server associated with the CPD Website 37a may also keep a count of number of times the CPD Website 37a was accessed by customers using the peripheral devices of the present invention. If desired, an icon button may be provided on the page of the CPD Website 37a which, upon clicking, connects the customer 36 automatically to the page of the main Website 38a.

The embodiment described above allows for promotion of a merchant's business by specially-configuring a user's existing computer system hardware to create a specially configured computer system having a specially configured switch allowing direct access to a predetermined Website (or providing other desired functionality), e.g. at the press of a button, and therefore allows for promotion of business (e.g. by causing an associated display of an advertisement for the merchant) at minimal cost, e.g. primarily at the cost of distribution of the software. It should be noted that this cost is particularly low when the software is distributed via Web download or e-mail.

In another embodiment, configuration software is not required to be installed on the user's computer system. Rather, promotion of the business is carried out via a traditional Website. More specifically, a user is provided with an access code, e.g. by providing the user with a credit card-like card or a gift card, by e-mailing a code, by mailing a code, etc. A Website is maintained, e.g. by the merchant, where the user is prompted to provide the code. After entering the code, the user is prompted to specify a URL of a Website of the user's choosing (e.g. user'sfavoritewebsite.com). This causes the user's Web browser to be directed to the Website provided via a redirect from the merchant's Website, every time the user types in or tries to go to the URL user's favorite website.com, an advertisement for the merchant's Website appears as a pop-up banner, etc. with specials, coupons, winning numbers, etc. In this manner, every time the user goes to his preferred Website the merchant's advertisement pop up and is displayed concurrently with the user's favorite Website. This promotes the business of the merchant.

Optionally, the user's membership expires after a given period of time. For example, the card with the access code could be given as a gift that is good for a limited period of time. Users take advantage of it because of the offers in the merchant's advertisements such as sweepstakes entries, specials, coupons, winning numbers, bonus points, savings clubs, etc. The concept is similar to giving a gift of a lottery ticket. After expiration of the initial time period, the user may pay to renew the code and continue to participate in the merchant's promotional program, i.e. to continue to receiving the merchant's advertisements each time the user goes to the user-specified Website. In this manner, the user can stay in the sweepstakes, keep receiving offers, etc. This provides a continuing revenue stream for the marketing agency. Revenue is also generated through selling of the gift cards and through merchants' payments for the advertisements and/or promotions.

Therefore, the business methods of the present invention provide an effective and powerful way for merchants to promote themselves to individuals through the merchant-specific computer system configuration software, and/or specially configured computer systems including a user's hardware and the inventive software. Furthermore, the merchant-specific configuration software allows a particular merchant to be distinguished over all other merchants due to the direct Website accessibility via the specially programmed switch as enabled by the configuration software. Moreover, Website tracking information obtained through the CPD Website can be used in market studies and research so that the business and visibility of the e-merchant can be further improved.

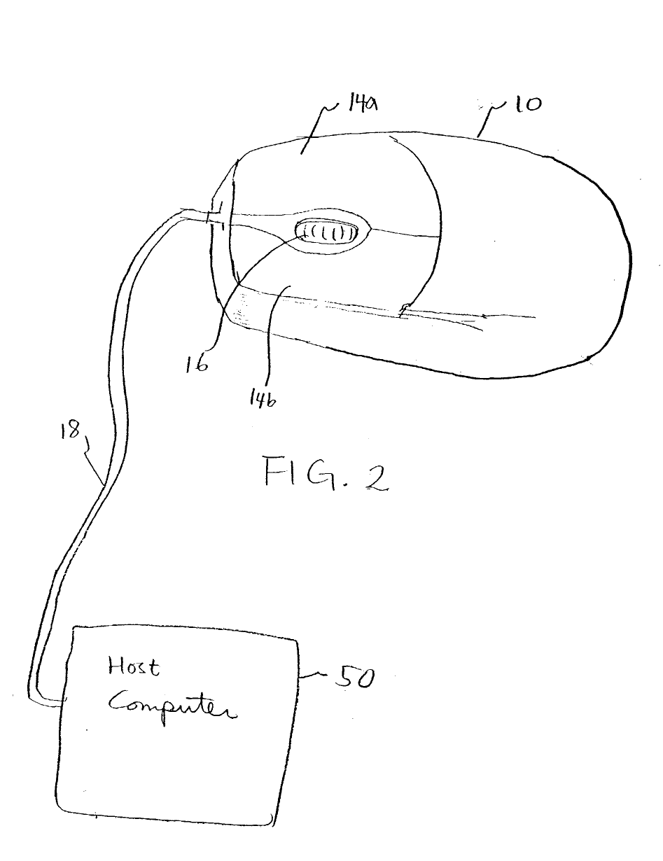

FIG. 2 shows a pictorial representation of a computer mouse according to a preferred embodiment of the present invention. The computer mouse of FIG. 2 is an example of a computer peripheral device that can be used to promote e-business as discussed hereinabove referring to FIG. 1.

The computer mouse 10 shown in FIG. 2 is a traditional mouse of a type well-known in the art. The mouse includes “right” and “left” switches 14a and 14b, a scroller 16 (optional), a mouse ball (not specifically shown) located underneath the mouse 10 for moving a cursor, and a connector 18 for connecting to a host computer 50 such as a desktop, a laptop, etc. The host computer 50 is set up with appropriate applications, such as the Web browser, user interface programs, operating systems, etc., for operating the computer and connecting to and accessing the Internet or other communications networks, e.g., intranets. Additionally, in accordance with the present invention, the host computer 50 is configured with configuration software according to the present invention to cause a predetermined trigger event to act as a specially programmed Web switch.

The specially programmed Web switch encompasses an actuating surface (e.g., a button) as well as any circuitry associated with it. The Web switch is “specially programmed” in that the computer system allows the user to access automatically at least one designated Website of a merchant (e.g., CPD Website 37a, or CPD Website 37a and main Website 38a) by activating the switch in a predetermined manner, e.g. to cause a trigger event such as double right click. Preferably, the configuration software stores appropriate data in RAM or long-term storage of the host computer to cause the Web switch to act in the desired manner.

In one embodiment, the Website data installed along with the configuration software and/or be provided by a user to be stored in a cookie, may include a Web address or URL of the designated Website, e.g., CPD Website of a merchant. In addition, the Website data may include a user's personal data (e.g., user's account information, user's PIN, shipping address, etc.) which may be associated with accessing the CPD Website or the main Website of a merchant. In this embodiment, when the user actuates the Web switch, namely by performing the predetermined trigger event such as a double right click of the mouse button, the URL of the designated Website and the user's personal data may be processed by the host computer 50 as if the URL had been entered by the user in the Web browser user interface and transmits it to an appropriate server through the Internet or other networks. The manner in which the host computer 50 processes and transmits the Web address such as the URL is well known in the art and will not be discussed in detail. The host computer 50 may also transmit the user's personal data to the server, if appropriate. For example, in some applications, the server may need the user's personal data (e.g., user's PIN or password) before it allows the user to access the designated Website. In other applications, the user's personal data (e.g., shipping address) may be used by the server as a substitute to the user's manual input.

The mouse ball located underneath the mouse 10, if the mouse 10 is of such type, allows the user to maneuver the cursor on the computer monitor by moving or rolling the ball on a surface. The “right” and “left” switches 14a and 14b are typically used to select items displayed on the video monitor using the cursor. The scroller 16, which is optional, is used to scroll down or up a page displayed on the monitor. The operations of these switches 14a, 14b, the scroller 16 and the mouse ball are well known in the art, e.g., see U.S. Pat. No. 5,530,455 to Gillick et al. which discloses a computer having such features. The disclosure of U.S. Pat. No. 5,530,455 is hereby incorporated herein by reference.

In accordance with other embodiments, the computer mouse 10 may include a plurality of specially programmed switches 12 such that multiple pre-designated Websites of a single e-merchant or multiple e-merchants may be selectively and directly accessed by the operation of these Web switches.

One skilled in the art would readily understand that various other modifications to the computer system and/or CPD may be possible without affecting the operation of the computer system and/or CPD and that such modifications are contemplated as part of the invention.

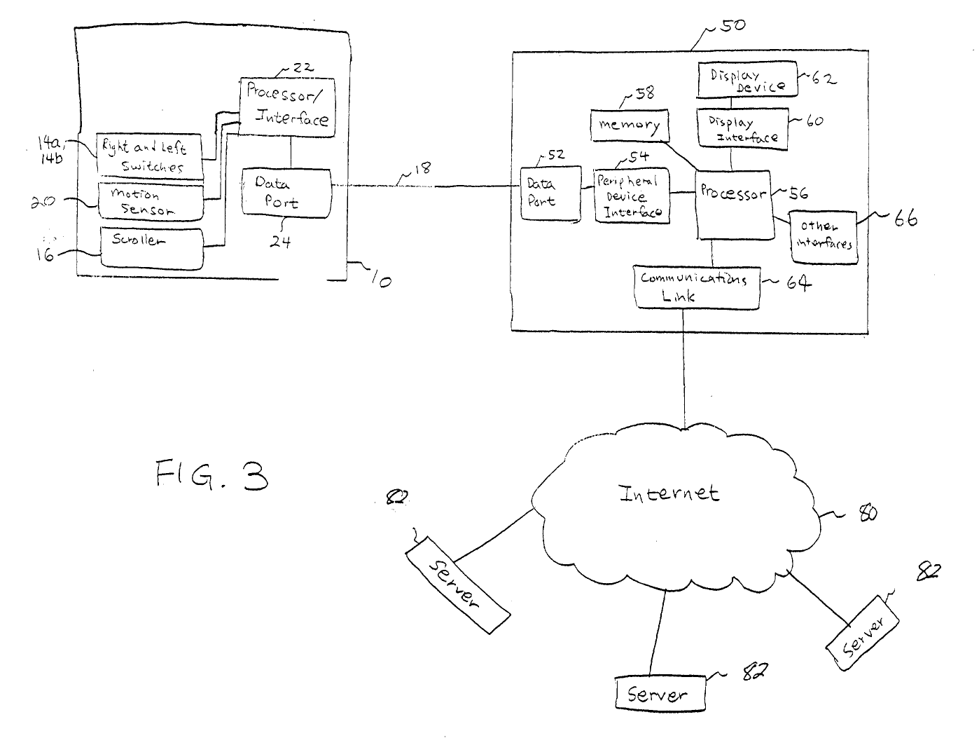

FIG. 3 shows a block diagram of a specially configured computer system including a traditional computer mouse 10 coupled to the host computer 50 in accordance with a preferred embodiment of the present invention. The computer mouse 10 can be plugged into the host computer 50 as shown in FIG. 3 or be coupled to it wirelessly.

The host computer 50 is connected to a communications network, such as the Internet 80, extranets, intranets, etc. Through the Internet 80 or other network, the host computer 50 can access any of servers 82 on the Internet 80. The servers 82 can be maintained by e-merchants, ISPs, ASPs, or other sponsors of Websites.

The motion sensor 20 of the mouse 10 detects a position of the mouse ball (if present) as is well known in the art. The processor/interface 22 processes signals from the switches 14a, 14b, the scroller 16, and the motion sensor 20, and the data port 24 transmits the processed signals from the processor/interface 22 to the host computer 50 through the connector 18 or wireless connection. The data port 24 and the processor/interface 22 may also receive and process signals from the host computer 50 as needed.

The predetermined Website data can be “pre-programmed” in a number of different ways. For instance, the predetermined Website data may be non-alterably stored in a memory 58 of the host computer 50 accessible by the processor/interface 56, 66, e.g. upon installation of the configuration software.

The host computer 50 may include a data port 52, a peripheral device interface 54, a processor 56, a memory 58 such as RAM or ROM, a display interface 60, a display device 62 such as a monitor, a communications link 64 for connecting to the Internet 80 or other networks, and additional peripheral device interfaces 66 (e.g., for a keyboard, a scanner, an optical pen, etc.), all operatively connected. Although not illustrated for the sake of clarity, the host computer 50 may include other components typically found in a computer, such as a keyboard, a CD driver, etc., and can be in any type of computer well known in the art, e.g., a desktop, a laptop, a workstation, etc.

The operation of the host computer 50 in connection with according to one embodiment of the present invention is as follows. Initially, the computer mouse 10 is connected to the user's host computer 50 and is operational. The user is then provided with computer software which must be installed in the host computer 50 to activate the functionality of the present invention. This software enables the host computer 50 to recognize and process a predetermined trigger event (e.g. a double right click) and provides the Website data for storage and use upon occurrence of the predetermined trigger event. Without the installation of such software, the mouse 10 may merely function as a conventional mouse. Once the host computer 50 is connected to the Internet 80, the user can cause the predetermined event to occur, e.g. by double right clicking the mouse, at any time. This activates the Web switch and causes the host computer's 50 processor/interface 56/66 to retrieve the pre-stored Website data (e.g., URL of the CPD Website of the merchant or a triggering signal).

The processor 56 receives the Website data and processes it according to the conventional methods of processing Website data. The processor 56 communicates the Website data to an appropriate server 82 on the Internet 80 using well-known HyperText Transport Protocols (HTTPs) or other established protocols.

The processor 56 receives from the server 82 the Web page data (e.g., HTML files) corresponding to the Website data and processes and displays it on the display device 62 through the display interface 60.

As mentioned above, once the host computer 50 is connected to the Internet 80, the user may initiate the direct Website accessing process of the present invention. In the alternative, the software installed in the host computer 50 may link the dial-up functions of the Web browser to the occurrence of the predetermined event, such that the predetermined event automatically commences the dial-up procedures for connecting to the Internet 100 and results in the display of the Web page of the predetermined Website(s) on the display device 62. Accordingly, the user can easily and conveniently access the designated Website.

In accordance with another embodiment, the concept of utilizing the preprogrammed Web switch(es) may be applied to other computer peripheral devices such as a keypad, a keyboard, a touch pad, a stylus, etc. Different command keys or buttons may be provided for different computer peripheral devices depending on the application and the Website accessible by the peripheral devices.

In accordance with another embodiment of the present invention, the system may be configured so that the customer is directly connected to the main Website of the e-merchant without the redirecting process offered by the CPD Website of the merchant.

In accordance with other embodiments, the system can be configured such that the user can register their personal information at the CPD Website. Upon installation of the merchant-specific peripheral device of the present invention and/or actuating a pre-programmed switch on the device connected to the PC, the user may be able to enter user information (e.g., name, address, phone number, etc.) which may be subsequently transmitted to the CPD Website or any other designated registration site for registering user information. The merchant can use the registered user information to develop user-specific tracking data for tracking Web access by each user, and to provide more individualized and personal service to the users.

Thus, the present invention offers many advantages. For instance, Internet users can easily and conveniently access predetermined Websites using the specially configured computer system of the present invention and in certain embodiments execute commands once such Websites have been accessed.

Moreover, the present invention may be utilized as advertising and market study tools through which the advertisers can gain competitive business edge into desired markets. The marketing agency provides to each merchant the merchant-specific configuration software wherein the Website data associated with the merchant is pre-programmed, the configuration system being then distributed to potential or current customers, either for free or for a fee.

The ease and convenience associated with operating a pre-programmed Web switch encourages the user to access more frequently the merchant's Website(s), either directly or by viewing an advertisement in conjunction with a Website of the user's choosing, and increases the visibility of the merchant and the likelihood of business transactions being conducted through that Website(s). Therefore, the present invention provides convenience to Internet users as well as competitive business advantages to merchants and Website sponsors, benefitting all parties involved in e-commerce.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

I claim:

1. A method of promoting a merchant comprising the step of providing merchant-specific configuration software for configuring a user's computer to perform a function by the activation of at least one switch by the user.

2. The method of claim 1 wherein the activation of the switch connects the user to a predetermined Website.

3. The method of claim 2 wherein the Website associated with the merchant.

4. The method of claim 1 wherein the activation of the switch displays an advertisement associated with the merchant.

5. The method of claim 3 wherein the activation of the switch also displays an advertisement associated with the merchant.

6. The method of claim 1 wherein the switch is located on a computer peripheral device.

7. The method of claim 6 wherein the computer peripheral device is a computer mouse.

8. The method of claim 7 wherein the switch comprises a double right click.

9. The method of claim 6 wherein the computer peripheral device is a keyboard.
